(19) United States
(12) Patent Application Publication
(10) Pub. No.: US 2025/0175786 A1
(43) Pub. Date: May 29, 2025

(54) MEASUREMENT METHOD AND APPARATUS

(71) Applicant: HUAWEI TECHNOLOGIES CO., LTD., Shenzhen (CN)

(72) Inventors: Shuigen YANG, Shenzhen (CN); Chuan MA, Shanghai (CN)

(21) Appl. No.: 19/041,267

(22) Filed: Jan. 30, 2025

Related U.S. Application Data
(63) Continuation of application No. 17/891,257, filed on Aug. 19, 2022, now Pat. No. 12,238,823.
Application No. 17/891,257 is a continuation of application No. PCT/CN2020/076253, filed on Feb. 21, 2020.

(51) Int. Cl. H04W 8/22; H04W 28/02; H04W 76/27

(52) U.S. Cl. CPC H04W 8/22; H04W 28/0215; H04W 28/0268; H04W 76/27

(57) ABSTRACT

A first access network device sends, to a terminal device, an application layer measurement configuration used to indicate the terminal device to perform quality of experience measurement and collection on a first service. The application layer measurement configuration includes a type of the first service and an indicator of quality of experience of the first service. The type of the first service includes one or more of AR, VR, and 5GMS. The first access network device receives an application layer measurement report from the terminal device. The application layer measurement report includes the type of the first service and a value corresponding to the indicator of quality of experience of the first service.

### CROSS-REFERENCE TO RELATED APPLICATIONS

This application is a continuation of U.S. patent application Ser. No. 17/891,257, filed on Aug. 19, 2022, which is a continuation of International Application No. PCT/CN2020/076253, filed on Feb. 21, 2020. All of the afore-mentioned patent applications are hereby incorporated by reference in their entireties.

### TECHNICAL FIELD

This application relates to the field of communication technologies, and in particular, to a measurement method and apparatus.

### BACKGROUND

With development of communication technologies, an emerging service such as augmented reality (augmented reality, AR), virtual reality (virtual reality, VR), or 5th generation media streaming (5th generation media streaming, 5GMS) emerges, and occupies a large market share. For example, when the AR is applied to fields such as navigation, information query, and entertainment, a user obtains more real interaction experience by using a terminal device having an AR application. For example, when the terminal device is AR glasses, and the user participates in an entertainment activity such as a game by using the AR glasses, the user may experience a panoramic and real game image by using VR glasses.

Currently, the user expects to have better experience when using the foregoing emerging service. To provide better experience for the user, a wireless network for transmitting the emerging service needs to meet a transmission requirement of the emerging service. Therefore, how to meet the transmission requirement of the foregoing emerging service becomes an urgent problem to be resolved currently.

### SUMMARY

This application provides a measurement method and apparatus, to meet a transmission requirement of an emerging service, and improve user experience when a user uses the emerging service.

To achieve the foregoing objectives, the following technical solutions are used in this application.

According to a first aspect, a measurement method is provided, and includes: A first access network device sends, to a terminal device, an application layer measurement configuration used to indicate the terminal device to perform quality of experience measurement and collection on a first service. The application layer measurement configuration includes a type of the first service and an indicator of quality of experience of the first service. The type of the first service includes one or more of AR, VR, and 5GMS. The first access network device receives, from the terminal device, an application layer measurement report that includes the type of the first service and a value corresponding to the indicator of quality of experience of the first service.

According to the measurement method provided in the first aspect, for an emerging service such as the VR, the AR, or the 5GMS of the terminal device, the access network device sends, to the terminal device, the application layer measurement configuration used to indicate the terminal device to perform quality of experience measurement and collection on the emerging service, so that the terminal device performs quality of experience measurement and collection on the emerging service based on the application layer measurement configuration, to obtain the application layer measurement report of the emerging service, and sends the application layer measurement report to the access network device. After receiving the application layer measurement report, a network side may perform, based on the value corresponding to the indicator of quality of experience in the application layer measurement report, network optimization on a wireless network used to transmit the service, so that an optimized wireless network can meet a transmission requirement of the service, to improve user experience when a user uses the first service.

In a possible implementation, with reference to the first aspect, the first access network device sends the application layer measurement configuration to the terminal device when the first access network device determines that the terminal device supports performing quality of experience measurement and collection on the first service.

Based on this possible implementation, when determining that the terminal device supports performing quality of experience measurement and collection on the first service, the first access network device may indicate the terminal device to perform quality of experience measurement and collection on the first service. This avoids a problem caused because the network side still indicates the terminal device to perform quality of experience measurement and collection when the terminal device does not support performing quality of experience measurement and collection on the first service/does not have a capability of performing quality of experience measurement and collection on the first service, and improves accuracy of performing quality of experience measurement and collection on the first service by the terminal device.

In a possible implementation, with reference to any one of the first aspect or the possible designs of the first aspect, the first access network device receives capability information from the terminal device. The capability information is used to indicate that the terminal device supports performing quality of experience measurement and collection on the first service. The first access network device determines, based on the capability information of the terminal device, that the terminal device supports performing quality of experience measurement and collection on the first service.

Based on this possible implementation, the access network device may learn, by exchanging signaling with the terminal device, that the terminal device supports performing quality of experience measurement and collection on the first service. This is simple and feasible.

In a possible implementation, with reference to any one of the first aspect or the possible designs of the first aspect, before receiving the capability information from the terminal device, the first access network device sends first query information to the terminal device. The first query information is used to obtain the capability information of the terminal device.

Based on this possible implementation, the access network device may request the terminal device to report the capability information of the terminal device, so that the terminal device reports the capability information of the terminal device after receiving the request of the access network device, to avoid power consumption caused by the terminal device reporting the capability information of the terminal device in advance or periodically, and reduce power consumption of the terminal device.

In a possible implementation, with reference to any one of the first aspect or the possible designs of the first aspect, the type of the first service and the indicator of quality of experience of the first service are sent by a second access network device or a core network device to the first access network device. Alternatively, the type of the first service and the indicator of quality of experience of the first service are configured by a control device in the first access network device.

Based on this possible implementation, the type of the first service and the indicator of quality of experience of the first service may be configured for the first access network device by using another access network device, core network device, or control device that manages the first service, to improve accuracy of configuring the indicator of quality of experience.

In a possible implementation, with reference to any one of the first aspect or the possible designs of the first aspect, the first access network device includes a centralized unit (centralized unit, CU) and a distributed unit (distributed unit, DU). The CU of the first access network device sends the application layer measurement configuration to the terminal device. The CU of the first access network device receives the application layer measurement report from the terminal device. The CU of the first access network device sends the application layer measurement report to the DU of the first access network device.

Based on this possible implementation, the measurement method provided in this application may be applied to a CU-DU split scenario, to improve flexibility and extensiveness of application of the measurement method.

According to a second aspect, a measurement apparatus is provided. The measurement apparatus is used in a first access network device or a chip or a system-on-a-chip in the first access network device, or may be a function module that is in the first access network device and that is configured to implement the method according to any one of the first aspect or the possible designs of the first aspect. The measurement apparatus may implement functions performed by the first access network device in the foregoing aspects or the possible designs, and the functions may be implemented by hardware executing corresponding software. The hardware or the software includes one or more modules corresponding to the foregoing functions. For example, the measurement apparatus includes a communication unit.

The communication unit is configured to send, to a terminal device, an application layer measurement configuration used to indicate the terminal device to perform quality of experience measurement and collection on a first service. The application layer measurement configuration includes a type of the first service and an indicator of quality of experience of the first service. The type of the first service includes one or more of AR, VR, and 5GMS.

The communication unit is further configured to receive, from the terminal device, an application layer measurement report that includes the type of the first service and a value corresponding to the indicator of quality of experience of the first service.

For a specific implementation of the measurement apparatus, refer to behavior and a function of the terminal device in the measurement method provided in any one of the first aspect or the possible designs of the first aspect. Details are not repeated herein again. Therefore, the provided measurement apparatus can achieve same beneficial effects as any one of the first aspect or the possible designs of the first aspect.

According to a third aspect, a measurement apparatus is provided. The measurement apparatus may be a first access network device or a chip or a system-on-a-chip in the first access network device. The measurement apparatus may implement functions performed by the first access network device in the foregoing aspects or the possible designs. The functions may be implemented by hardware. For example, in a possible design, the measurement apparatus may include a processor and a communication interface. The processor may be configured to support the measurement apparatus in implementing the functions in any one of the first aspect or the possible designs of the first aspect. For example, the processor is configured to send, to a terminal device through the communication interface, an application layer measurement configuration used to indicate the terminal device to perform quality of experience measurement and collection on a first service. The application layer measurement configuration includes a type of the first service and an indicator of quality of experience of the first service. The type of the first service includes one or more of AR, VR, and 5GMS.

In another possible design, the measurement apparatus may further include a memory. The memory is configured to store computer-executable instructions and data that are necessary for the measurement apparatus. When the measurement apparatus runs, the processor executes the computer-executable instructions stored in the memory, so that the measurement apparatus is enabled to perform the measurement method according to any one of the first aspect or the possible designs of the first aspect.

According to a fourth aspect, a computer-readable storage medium is provided. The computer-readable storage medium may be a readable non-volatile storage medium. The computer-readable storage medium stores computer instructions or a program. When the computer instructions or the program is run on a computer, the computer is enabled to perform the measurement method according to any one of the first aspect or the possible designs of the foregoing aspect.

According to a fifth aspect, a computer program product including instructions is provided. When the computer program product runs on a computer, the computer is enabled to perform the measurement method according to any one of the first aspect or the possible designs of the foregoing aspect.

According to a sixth aspect, a measurement apparatus is provided. The measurement apparatus may be a first access network device or a chip or a system-on-a-chip in the first access network device. The measurement apparatus includes one or more processors and one or more memories. The one or more memories are coupled to the one or more processors, and the one or more memories are configured to store computer program code. The computer program code includes computer instructions. When the one or more processors execute the computer instructions, a terminal device is enabled to perform the measurement method according to any one of the first aspect or the possible designs of the first aspect.

According to a seventh aspect, a chip system is provided. The chip system includes a processor and a communication interface. The chip system may be configured to implement functions performed by a terminal device according to any one of the first aspect or the possible designs of the first aspect. For example, the processor is configured to send, to the terminal device through the communication interface, an application layer measurement configuration used to indicate the terminal device to perform quality of experience measurement and collection on a first service. The application layer measurement configuration includes a type of the first service and an indicator of quality of experience of the first service. The type of the first service includes one or more of AR, VR, and 5GMS. In a possible design, the chip system further includes a memory. The memory is configured to store program instructions and/or data. The chip system may include a chip, or may include a chip and another discrete component. This is not limited herein.

For technical effects achieved by any one of the designs of the second aspect to the seventh aspect, refer to the technical effects achieved by any one of the first aspect or the possible designs of the first aspect. Details are not described again.

According to an eighth aspect, a measurement method is provided. The measurement method includes: A terminal device receives an application layer measurement configuration from a first access network device. The application layer measurement configuration includes a type of a first service and an indicator of quality of experience of the first service. The type of the first service includes one or more of AR, VR, and 5GMS. The terminal device performs quality of experience measurement and collection on the first service based on the application layer measurement configuration, to obtain an application layer measurement report that includes the type of the first service and a value corresponding to the indicator of quality of experience of the first service. The terminal device sends the application layer measurement report to the first access network device.

According to the method described in the eighth aspect, when receiving the application layer measurement configuration from the first access network device, the terminal device may perform quality of experience measurement and collection on the first service based on the application layer measurement configuration, and send the application layer measurement report to the first access network device, so that a network side optimizes a wireless network based on the value corresponding to the indicator of quality of experience in the application layer measurement report. Therefore, an optimized wireless network can meet a transmission requirement of the service, to improve user experience when a user uses the first service.

In a possible implementation, the terminal device sends capability information of the terminal device to the first access network device. The capability information is used to indicate that the terminal device supports performing quality of experience measurement and collection on the first service.

Based on this possible implementation, with reference to the eighth aspect, the terminal device sends the capability information of the terminal device to the first access network device, to avoid a problem caused because the terminal device still receives the application layer measurement configuration from the first access network device when the terminal device does not support performing quality of experience measurement and collection on the first service/does not have a capability of performing quality of experience measurement and collection on the first service, and improve accuracy of performing quality of experience measurement and collection on the first service by the terminal device.

In a possible implementation, with reference to any one of the eighth aspect or the possible designs of the eighth aspect, the terminal device receives, from the first access network device, first query information that is used to obtain the capability information of the terminal device.

Based on this possible implementation, the terminal device may report the capability information of the terminal device after receiving a request of the access network device, so that the terminal device can avoid power consumption caused by reporting the capability information of the terminal device in advance or periodically, and reduce power consumption of the terminal device.

According to a ninth aspect, a measurement apparatus is provided. The measurement apparatus is used in a terminal device or a chip or a system-on-a-chip in the terminal device; or may be a function module that is in the terminal device and that is configured to implement the method according to any one of the eighth aspect or the possible designs of the eighth aspect. The measurement apparatus may implement functions performed by the terminal device in the foregoing aspects or the possible designs, and the functions may be implemented by hardware executing corresponding software. The hardware or the software includes one or more modules corresponding to the foregoing functions. For example, the measurement apparatus includes a communication unit and a processing unit.

The communication unit is configured to receive, from a first access network device, an application layer measurement configuration that includes a type of a first service and an indicator of quality of experience of the first service. The type of the first service includes one or more of AR, VR, and 5GMS.

The processing unit is configured to perform quality of experience measurement and collection on the first service based on the application layer measurement configuration, to obtain an application layer measurement report that includes the type of the first service and a value corresponding to the indicator of quality of experience of the first service. The communication unit is further configured to send the application layer measurement report to the first access network device.

In a possible design, the communication unit is further configured to send capability information of the terminal device to the first access network device. The capability information is used to indicate that the terminal device supports performing quality of experience measurement and collection on the first service.

In a possible design, the communication unit is further configured to receive, from the first access network device, first query information that is used to obtain the capability information of the terminal device.

According to a tenth aspect, a measurement apparatus is provided. The measurement apparatus may be a terminal device or a chip or a system-on-a-chip in the terminal device. The measurement apparatus may implement functions performed by the terminal device in the foregoing aspects or the possible designs. The functions may be implemented by hardware. For example, in a possible design, the measurement apparatus may include a processor and a communication interface. The communication interface is coupled to the processor. The processor is configured to run a computer program or instructions, to implement the measurement method according to any one of the eighth aspect and the possible implementations of the eighth aspect.

According to an eleventh aspect, a computer-readable storage medium is provided. The computer-readable storage medium may be a readable non-volatile storage medium. The computer-readable storage medium stores computer instructions or a program. When the computer instructions or the program is run on a computer, the computer is enabled to perform the measurement method according to any one of the eighth aspect or the possible designs of the eighth aspect.

According to a twelfth aspect, a computer program product including instructions is provided. When the computer program product runs on a computer, the computer is enabled to perform the measurement method according to any one of the eighth aspect or the possible designs of the eighth aspect.

According to a thirteenth aspect, a measurement apparatus is provided. The measurement apparatus may be a first access network device or a chip or a system-on-a-chip in the first access network device. The measurement apparatus includes one or more processors and one or more memories. The one or more memories are coupled to the one or more processors, and the one or more memories are configured to store computer program code. The computer program code includes computer instructions. When the one or more processors execute the computer instructions, a terminal device is enabled to perform the measurement method according to any one of the eighth aspect or the possible designs of the eighth aspect.

According to a fourteenth aspect, a chip is provided, and includes a processor and a communication interface. The processor is coupled to a memory through the communication interface. When the processor executes a computer program or instructions in the memory, the measurement method according to any one of the eighth aspect and the possible implementations of the eighth aspect is performed.

For technical effects achieved by any one of the designs of the ninth aspect to the fourteenth aspect, refer to the technical effects achieved by any one of the eighth aspect or the possible designs of the eighth aspect. Details are not described again.

According to a fifteenth aspect, this application provides a communication system, including a first access network device and a terminal device that communicates with the first access network device. The first access network device is configured to perform the measurement method according to any one of the first aspect and the possible implementations of the first aspect. The terminal device is configured to perform the measurement method according to any one of the eighth aspect and the possible implementations of the eighth aspect.

### BRIEF DESCRIPTION OF DRAWINGS

FIG. 1 is a simplified schematic diagram of a communication system according to an embodiment of this application;

FIG. 2 is a schematic diagram of an architecture of a CU-DU split access network device in a communication system according to an embodiment of this application;

FIG. 3 is a schematic composition diagram of a measurement apparatus according to an embodiment of this application;

FIG. 4 is a flowchart of a measurement method according to an embodiment of this application;

FIG. 5 is a schematic diagram of a user interface (user interface, UI) of a terminal device according to an embodiment of this application;

FIG. 6 is a flowchart of another measurement method according to an embodiment of this application;

FIG. 7A and FIG. 7B are a flowchart of still another measurement method according to an embodiment of this application;

FIG. 8 is a flowchart of still another measurement method according to an embodiment of this application;

FIG. 9 is a schematic diagram of a structure of a measurement apparatus 90 according to an embodiment of this application;

FIG. 10 is a schematic diagram of a structure of a measurement apparatus 100 according to an embodiment of this application; and FIG. 11 is a schematic diagram of a structure of a communication system according to an embodiment of this application.

### DESCRIPTION OF EMBODIMENTS

In embodiments of this application, the word “example”, “for example”, or the like is used to represent giving an example, an illustration, or a description. Any embodiment or design scheme described as an “example” or “for example” in embodiments of this application should not be explained as being more preferred or having more advantages than another embodiment or design scheme. Exactly, use of the word “example” or “for example” is intended to present a related concept in a specific manner.

The following terms “first” and “second” are merely intended for a purpose of description, and shall not be understood as an indication or implication of relative importance or implicit indication of a number of indicated technical features. Therefore, a feature limited by “first” or “second” may explicitly or implicitly include one or more features. In the descriptions of embodiments of this application, “a plurality of” means two or more than two unless otherwise specified.

Before describing embodiments of this application, terms used in embodiments of this application are explained and described.

AR is a technology that integrates virtual information with the real world. The AR may provide a user with additional information superimposed in a current user environment, a human generated item, or human generated content. The additional information or the human generated item or content is usually visible and/or audible. Observation on the current environment may be direct or indirect. “Direct” means that there is no intermediate sensing, processing, and rendering. “Indirect” means that perception of the environment is relayed by using a sensor and may be enhanced or processed.

VR is a technology that integrates a computer, electronic information, and a simulation technology. A basic implementation of the VR is that the computer simulates a virtual environment, to give a sense of environment immersion to a person. The VR is a delivery of rendered versions of visual and audio scenes. When a user moves within a limitation specified by an application, a rendering program is designed to mimic as naturally as possible visual and auditory sensational stimuli of the real world.

5GMS: A medium that transmits a time relation is used as a main medium. 5GMS points to a fact that a medium is mainly sent and consumed in a single direction, and the medium is received by a peer end. In addition, content of the medium may be streamed during production.

It should be noted, a service that is described in embodiments of this application is intended to describe the technical solutions in embodiments of this application more clearly, but constitute no limitation on the technical solutions provided in embodiments of this application. A person of ordinary skill in the art may know that, with evolution of a network architecture and emergence of another emerging service, the technical solutions provided in embodiments of this application are also applicable to similar technical problems.

In embodiments of this application, to improve user experience when a user uses an emerging service such as AR, VR, or 5GMS, a measurement method is provided, and includes: An access network device sends an application layer measurement configuration to a terminal device. The application layer measurement configuration is used to indicate the terminal device to perform quality of experience measurement and collection on one or more of the AR, the VR, and the 5GMS. The application layer measurement configuration includes an indicator of quality of experience of the one or more services of the AR, the VR, and the 5GMS. After obtaining an application layer measurement report based on the application layer measurement configuration, the terminal device sends the application layer measurement report to the access network device. Correspondingly, the access network device receives, from the terminal device, the application layer measurement report that includes a value corresponding to the indicator of quality of experience of the one or more services of the AR, the VR, and the 5GMS. The access network device may perform, based on the value corresponding to the indicator of quality of experience in the application layer measurement report, network optimization on a wireless network used to transmit the service, so that an optimized wireless network can meet a transmission requirement of the service.

It should be noted that, in embodiments of this application, quality of experience (quality of experience, QoE) measurement and collection may mean collection of an experience status when the user uses a service on a terminal device. The quality of experience measurement and collection may also be referred to as application layer measurement and collection, application layer measurement, quality of experience measurement, or the like.

The indicator of quality of experience of the service may include a performance parameter of the terminal device that can use the service and/or quality of experience of the user on the service of the terminal device when the user uses the service on the terminal device. It should be noted that, in embodiments of this application, the quality of experience may be alternatively described as user experience, customer experience, or the like. This is not limited.

For example, the indicator of quality of experience of the AR or the VR is shown in Table 1, and may include: video bitrate, a video frame rate, resolution-horizontal, resolution-vertical, screen resolution-horizontal, a screen refresh rate, a number of video channels, video codec, a field of view, audio bitrate, a number of audio channels, audio codec, an audio sampling rate, asynchronous time, re-buffering time, a re-buffering frequency, a packet loss rate, a black edge rate, a head motion to photons latency, a head motion to sound latency, a body motion to photons latency, an operation response delay, a degree of freedom, spatial interaction, video quality, audio quality, interactive response quality, spatial interaction quality, immersion experience quality, presenting experience quality, interactive experience quality, and a mean opinion score. For a description of each indicator of quality of experience, refer to Table 1. Details are not described.

TABLE 1

| | | Description of the indicator |
|---|---|---|
| No. | Indicator of quality of experience | of quality of experience |
| 1 | Video bitrate (video bitrate) | Volume of video data transmitted per |
| | | unit of time |
| 2 | Video frame rate | Number of video/game frames displayed on |
| | (video frame rate) | a terminal device per second |
| 3 | Resolution-horizontal | Number of video/game pixels displayed on |
| | (resolution-horizontal) | the terminal device in a horizontal direction |
| 4 | Resolution-vertical | Number of video/game pixels displayed on |
| | (resolution-vertical) | the terminal device in a vertical direction |
| 5 | Screen resolution-horizontal | Number of pixels in a monocular screen of a |
| | (screen resolution-horizontal) | head-mounted visualized device in a |
| | | horizontal direction |
| 6 | Screen refresh rate | Number of screen refresh times per second |
| | (screen refresh rate) | of the head-mounted visualized device |
| 7 | Number of video channels | Monocular vision or stereoscopic vision |
| | (number of video channels) | |
| 8 | Video codec (video codec) | Video codec standards, such as |
| | | H.265/HEVC, H.264/AVC, VP9, and |
| | | AVS2/3 |
| 9 | Field of view (field of view) | Monocular field of view of a head-mounted |
| | | visualized terminal device in a horizontal |
| | | direction |
| 10 | Audio bitrate (audio bitrate) | Volume of audio data transmitted per unit of |
| | | time |
| 11 | Number of audio channels | Stereo sound, surround sound, or spatialized |
| | (number of audio channels) | sound |
| 12 | Audio codec (audio codec) | Audio codec standards, such as AAC-LC, |
| | | Opus, and DD+ |
| 13 | Audio sampling rate | Frequency of audio sampling |
| | (audio sampling rate) | |
| 14 | Asynchronous time | Audio and video synchronization latency of |
| | (asynchronous time) | a video/game |
| 15 | Re-buffering time | Average re-buffering time during video |
| | (re-buffering time) | watching or game playing |
| 16 | Re-buffering frequency | Ratio of a number of re-buffering times to |
| | (re-buffering frequency) | total duration of video or game playing in |
| | | response to the terminal device playing a |
| | | video or a game |
| 17 | Packet loss rate | Application packet loss rate of the terminal |
| | (packet loss rate) | device |
| 18 | Black edge rate | Proportion of black edges to an image in |
| | (black edge rate) | secondary rendering in response to a head of |
| | | a user rotates or moves |
| 19 | Head motion to photons latency | Lapse between a user head rotation and an |
| | (head motion to photons latency) | image refresh |
| 20 | Head motion to sound latency | Lapse between a user head rotation and an |
| | (head motion to sound latency) | audio direction change |
| 21 | Body motion to photons latency | Lapse between a user body motion and body |
| | (body motion to photons latency) | movement in an image refresh |
| 22 | Operation response delay | Lapse between a user operation and an |
| | (operation response delay) | operation response |
| 23 | Degree of freedom | Number of spatial dimensions supported by |
| | (degree of freedom) | an application system of the terminal device |
| | | for interaction and operation, which is |
| | | represented by a number of nodes (such as |
| | | the head, hand, and body) that support |
| | | interaction and a number of interaction |
| | | dimensions supported by a node |
| 24 | Spatial interaction accuracy | Spatial error of interactions, such as user |
| | (spatial interaction accuracy) | head tracking, motion capturing, gesture |
| | | recognition, and direction tracking |
| 25 | Video quality (video quality) | Score of a user for quality of video image |
| | | fidelity |
| 26 | Audio quality (audio quality) | Score of the user for quality of audio fidelity |
| 27 | Interactive response quality | Score of the user for quality of an |
| | (interactive response quality) | interaction latency |
| 28 | Spatial interaction quality | Score of the user for quality of the degree of |
| | (spatial interaction quality) | freedom and interaction accuracy |
| 29 | Immersion experience quality | Score of the user for quality of image and |
| | (immersion experience quality) | audio fidelity and immersion experience |
| 30 | Presenting experience quality | Score of the user for quality of VR or AR |
| | (presenting experience quality) | experience, where the quality is used to |
| | | represent network transmission quality, such |
| | | as a packet loss and a latency |
| 31 | Interactive experience quality | Score of the user for fidelity of interaction |
| | (interactive experience quality) | between VR or AR content and a VR device |
| | | or an AR device |
| 32 | Mean opinion score | Comprehensive score of the user for quality |
| | (mean opinion score) | of VR or AR experience |

It should be noted that the indicator of quality of experience of the AR or the VR may include one or more of the indicators of quality of experience in Table 1. The user in Table 1 is a user who uses the terminal device, and may also be referred to as a “customer”. The terminal device may be a device that supports the AR or the VR. The terminal device may be referred to as an AR device or a VR device. In addition, Table 1 is merely an example table. In addition to the indicators of quality of experience shown in Table 1, another indicator of quality of experience may be further included. This is not limited.

The indicators of quality of experience whose sequence numbers are 1 to 24 in Table 1 are performance parameters of the terminal device, for example, may be performance parameters of hardware or software configured in the terminal device. Values of the indicators of quality of experience are preconfigured or set at delivery. The values of the indicators of quality of experience are corresponding to features of the hardware or software configured in the terminal device, and may be the performance parameters of the hardware or software. The screen resolution-horizontal whose sequence number is 5 in Table 1 is used as an example. The screen resolution-horizontal of the terminal device is related to firmware such as a graphics card and a display of the terminal device. The screen resolution-horizontal of the terminal device may be feature parameters of the graphics card and the display of the terminal device. Better performance of the graphics card and the display of the terminal device indicates higher screen resolution-horizontal.

The indicators of quality of experience whose sequence numbers are 25 to 32 in Table 1 are quality of experience of the user on the AR or the VR of the terminal device when the user uses the AR or the VR on the terminal device. Values corresponding to the indicators of quality of experience may be determined based on a usage status of the user. The values of the indicators of quality of experience may be obtained by performing quality of experience measurement and collection on the AR or the VR.

For example, the indicator of quality of experience of the 5GMS may be shown in Table 2, and may include corruption duration, a successive loss of real-time transport protocol packet, a frame rate, jitter duration, synchronization loss duration, round-trip time, average codec bitrate, and codec information. For a description of each indicator of quality of experience, refer to Table 2. Details are not described.

TABLE 2

| | Indicator of | |
|---|---|---|
| No. | quality of experience | Description of the indicator of quality of experience |
| 1 | Corruption duration | Interval between network time protocol time of the last |
| | (corruption duration) | good frame that is used before video corruption occurs |
| | | and network time protocol time of the first subsequent |
| | | good frame |
| 2 | Successive loss of real-time | Number of the real-time transport protocol packets that |
| | transport protocol packets | are successively lost on one or more media channels of |
| | (successive loss of real-time | a terminal device |
| | transport protocol packets) | |
| 3 | Frame rate (frame rate) | A play frame rate, which is equal to a value obtained |
| | | after a number of frames displayed in a measurement |
| | | resolution periodicity is divided by a time length with a |
| | | unit of seconds |
| 4 | Jitter duration (jitter duration) | In response to an absolute difference between actual |
| | | play time and expected play time being greater than a |
| | | jitter threshold, a video stream jitters, and the jitter |
| | | threshold is the jitter duration, where the expected play |
| | | time = actual play time of a previous frame + network time |
| | | protocol time of a current frame-network time protocol |
| | | time of the previous frame |
| 5 | Synchronization loss duration | In response to an absolute difference between a value A |
| | (sync loss duration) | and a value B being greater than a synchronization |
| | | threshold, synchronization loss occurs, and the |
| | | synchronization threshold is the synchronization loss |
| | | duration, where the value A indicates a difference |
| | | between play time of the last play frame of a video |
| | | stream and play time of the last play frame of an audio |
| | | stream, and the value B indicates a difference between |
| | | expected play time of the last play frame of the video |
| | | stream and expected play time of the last play frame of |
| | | the audio stream |
| 6 | Round-trip time (round-trip | Round-trip time at a real-time transport protocol level |
| | time) | plus an extra two-way latency caused by buffering and |
| | | other processing on a client of the terminal device |
| 7 | Average codec bitrate | A rate used by the terminal device to encode and decode |
| | (average codec bitrate) | active media information within statistical duration, |
| | | where the active media information means a video |
| | | stream played by the terminal device |
| 8 | Codec information (codec | Media codec information used by a terminal device in a |
| | information) | receiving direction within statistical duration |

It should be noted that the indicator of quality of experience of the 5GMS may include one or more indicators of quality of experience in Table 2. The terminal device in Table 2 may be a device supporting the 5GMS. The terminal device may be referred to as a 5GMS device. In addition, Table 2 is merely an example table. In addition to the indicators of quality of experience shown in Table 2, another indicator of quality of experience of the 5GMS may be further included. This is not limited.

The indicators of quality of experience in Table 2 are quality of experience of the user on the 5GMS of the terminal device when the user uses the 5GMS on the terminal device. Values of the indicators of quality of experience may be determined based on a usage status of the user. The values of the indicators of quality of experience may be obtained by performing quality of experience measurement and collection on the 5GMS.

The following describes implementations of embodiments of this application in detail with reference to the accompanying drawings.

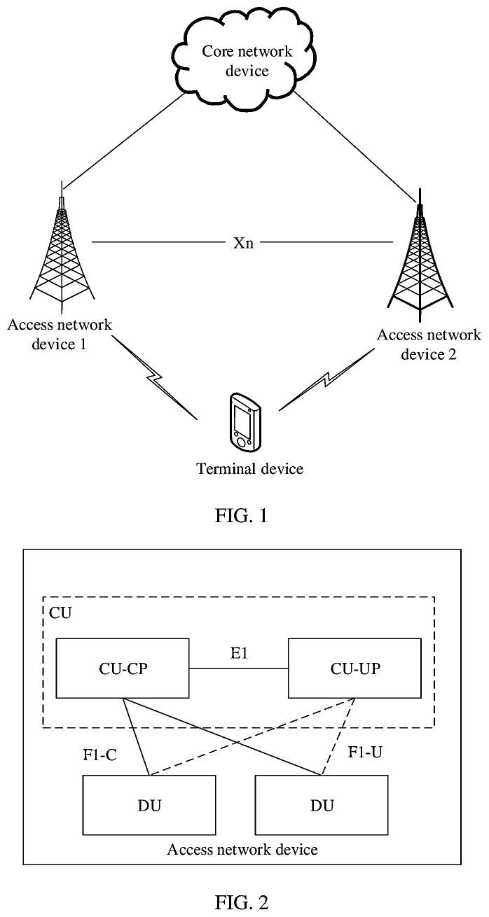

The measurement method provided in embodiments of this application may be applied to any communication system that supports communication. The communication system may be a 3rd Generation Partnership Project (3rd generation partnership project, 3GPP) communication system, for example, a 5G mobile communication system, a new radio (new radio, NR) system, an NR vehicle-to-everything (vehicle-to-everything, V2X) system, or another next-generation communication system, or may be a non-3GPP communication system. This is not limited. The following uses FIG. 1 as an example to describe the measurement method provided in embodiments of this application.

FIG. 1 is a simplified schematic diagram of a communication system according to an embodiment of this application. As shown in FIG. 1, the communication system may include a core network device, an access network device 1, an access network device 2, and a terminal device.

The terminal device is communicatively connected to the access network device 1 and/or the access network device 2. The terminal device may be communicatively connected to the core network device by using the access network device 1 and/or the access network device 2. The terminal device is located within a coverage area of the access network device 1 and/or a coverage area of the access network device 2. For example, the terminal device may be located in an overlapping area between the coverage area of the access network device 1 and the coverage area of the access network device 2. Alternatively, the terminal device may be located within the coverage area of the access network device 1, and located outside the coverage area of the access network device 2. Alternatively, the terminal device may be located outside the coverage area of the access network device 1, and located within the coverage area of the access network device 2. Different access network devices may be communicatively connected through an Xn interface.

When the terminal device communicates with both the access network device 1 and the access network device 2, in other words, the communication system is a multi-radio dual connectivity (multi-radio dual connectivity, MR-DC) communication system, one of the access network device 1 and the access network device 2 may be a master access network device, and the other access network device may be a secondary access network device. For example, in the following embodiment, an example in which a first access network device (the access network device 1) may be a secondary access network device, and a second access network device (the access network device 2) may be a master access network device is used for description. In a scenario in which the communication system is the MR-DC communication system, the access network device 1 and the access network device 2 may be access network devices of different communication standards, or may be access network devices of a same communication standard. This is not limited.

The core network device in FIG. 1 may be a device or an entity in a 5G core (5th generation core, 5GC) network, for example, an access and mobility management function (access and mobility management function, AMF). Alternatively, the core network device may be a device or an entity in a 4G core network (for example, an evolved packet core (evolved packet core, EPC)), for example, a mobility management entity (mobility management entity, MME). The core network device may be responsible for functions such as access control, mobility management, attachment and detachment, and gateway selection.

The terminal device in FIG. 1 may be referred to as a terminal, or may be referred to as user equipment (user equipment, UE), an access terminal device, a subscriber unit, a subscriber station, a mobile station, a remote station, a remote terminal device, a mobile device, a user terminal device, a wireless communication device, a user agent, a user apparatus, or the like. The terminal device may be a wireless terminal device or a wired terminal device. The wireless terminal device may be a device having a wireless transceiver function, and may be deployed on land, including an indoor or outdoor device, a handheld device, or a vehicle-mounted device; or may be deployed on water (for example, on a ship); or may be deployed in the air (for example, on an airplane, a balloon, or a satellite). The terminal device may be an unmanned aerial vehicle, an Internet of Things (internet of things, IoT) device (for example, a sensor, an electricity meter, or a water meter), a vehicle-to-everything (vehicle-to-everything, V2X) device, a station (station, ST) in a wireless local area network (wireless local area network, WLAN), a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device or another processing device connected to a wireless modem, a vehicle-mounted device, or a wearable device (which may also be referred to as a wearable intelligent device). The wearable device may be a head-mounted visualized device, for example, a VR helmet, VR glasses, an AR helmet, or AR glasses. The terminal device may alternatively be a terminal device in a next-generation communication system, for example, a terminal device in a 5G communication system, a terminal device in a future evolved public land mobile network (public land mobile network, PLMN), or a terminal device in an NR communication system. This is not limited herein.

The access network device in FIG. 1 is mainly configured to implement functions such as resource scheduling, radio resource management, and radio access control of the terminal device. Specifically, the access network device may include any node of a small base station, a radio access point, a transmission reception point (transmission reception point, TRP), a transmission point (transmission point, TP), a next-generation NodeB (generation NodeB, gNB), and another access node. In embodiments of this application, an apparatus configured to implement the functions of the access network device may be the access network device, or may be an apparatus that can support the access network device in implementing the functions, for example, a chip system. The apparatus may be installed in the access network device. In the technical solutions provided in embodiments of this application, the technical solutions provided in embodiments of this application are described by using an example in which the apparatus configured to implement the functions of the access network device is the access network device and the access network device is a base station.

As shown in FIG. 2, the access network device may be an access network device in which a centralized unit (centralized unit, CU) and a distributed unit (distributed unit, DU) are split. As shown in FIG. 2, one access network device includes one CU and two DUs. Further, one CU may include one centralized unit control plane (CU-control plane, CU-CP) and one or more centralized unit user planes (CU-user planes, CU-UPs). For example, as shown in FIG. 2, one CU includes one CU-CP. The CU may be connected to the DU through an F1 interface. The CU-CP may be connected to the CU-UP through an E1 interface. The CU-CP may be connected to the DU through an F1-control plane interface (F1-C). The CU-UP may be connected to the DU through an F1-user plane interface (F1-U). For functions of the CU, the DU, the CU-CP, and the CU-UP, refer to the conventional technology. Details are not described herein.

It should be noted that FIG. 1 is an example of an accompanying drawing, and a quantity of network elements shown in FIG. 1 and naming of the interfaces between the network elements in FIG. 1 are not limited. In addition to the network elements shown in FIG. 1, the communication system shown in FIG. 1 may further include another network element. This is not limited.

It should be noted that FIG. 2 is an example of an accompanying drawing, and a quantity of network elements shown in FIG. 2 and naming of the interfaces between the network elements in FIG. 2 are not limited.

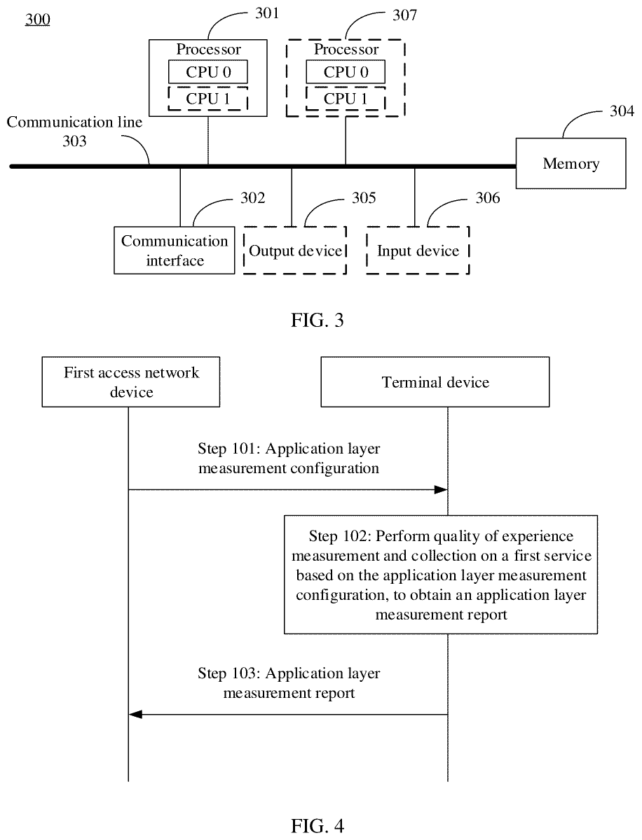

During specific implementation, FIG. 1 may be in a composition structure shown in FIG. 3 or include components shown in FIG. 3. FIG. 3 is a schematic composition diagram of a measurement apparatus 300 according to an embodiment of this application. The measurement apparatus 300 may be a terminal device or a chip or a system-on-a-chip in the terminal device. Alternatively, the measurement apparatus 300 may be a first access network device or a chip or a system-on-a-chip in the first access network device. As shown in FIG. 3, the measurement apparatus 300 includes a processor 301, a communication interface 302, and a communication line 303.

Further, the measurement apparatus 300 may include a memory 304. The processor 301, the memory 304, and the communication interface 302 may be connected to each other through the communication line 303.

The processor 301 is a central processing unit (central processing unit, CPU), a general-purpose processor, a network processor (network processor, NP), a digital signal processor (digital signal processor, DSP), a microprocessor, a microcontroller, a programmable logic device (programmable logic device, PLD), or any combination thereof. Alternatively, the processor 301 may be another apparatus having a processing function, for example, a circuit, a component, or a software module. This is not limited.

The communication interface 302 is configured to communicate with another device or another communication network. The another communication network may be Ethernet, a radio access network (radio access network, RAN), a wireless local area network (wireless local area network, WLAN), or the like. The communication interface 302 may be a module, a circuit, a communication interface, or any apparatus that can implement communication.

The communication line 303 is configured to transmit information between components included in the measurement apparatus 300.

The memory 304 is configured to store instructions. The instructions may be a computer program.

The memory 304 may be a read-only memory (read-only memory, ROM) or another type of static storage device that can store static information and/or instructions, or may be a random access memory (random access memory, RAM) or another type of dynamic storage device that can store information and/or instructions, an electrically erasable programmable read-only memory (electrically erasable programmable read-only memory, EEPROM), a compact disc read-only memory (compact disc read-only memory, CD-ROM) or another compact disc storage, an optical disc storage (including a compressed optical disc, a laser disc, an optical disc, a digital versatile disc, a Blu-ray disc, or the like), a magnetic disk storage medium or another magnetic storage device, or the like. This is not limited.

It should be noted that the memory 304 may exist independently of the processor 301, or may be integrated with the processor 301. The memory 304 may be configured to store instructions, program code, some data, or the like. The memory 304 may be located inside the measurement apparatus 300, or may be located outside the measurement apparatus 300. This is not limited. The processor 301 is configured to execute the instructions stored in the memory 304, to implement the measurement methods provided in the following embodiments of this application.

In an example, the processor 301 may include one or more CPUs, for example, a CPU 0 and a CPU 1 in FIG. 3.

In an optional implementation, the measurement apparatus 300 includes a plurality of processors. For example, in addition to the processor 301 in FIG. 3, the measurement apparatus 300 may further include a processor 307.

In an optional implementation, the measurement apparatus 300 further includes an output device 305 and an input device 306. For example, the input device 306 is a device such as a keyboard, a mouse, a microphone, or a joystick, and the output device 305 is a device such as a display or a speaker (speaker).

It should be noted that the measurement apparatus 300 may be a desktop computer, a portable computer, a network server, a mobile phone, a tablet computer, a wireless terminal, an embedded device, a chip system, or a device with a structure similar to that in FIG. 3. In addition, the composition structure shown in FIG. 3 does not constitute a limitation on the terminal device. In addition to the components shown in FIG. 3, the terminal device may include more or fewer components than those shown in the figure, or combine some components, or have different component arrangements.

In embodiments of this application, the chip system may include a chip, or may include a chip and another discrete component.

In addition, mutual reference may be made to actions, terms, and the like in embodiments of this application. This is not limited. In embodiments of this application, names of messages exchanged between devices, names of parameters in the messages, or the like are merely examples. Another name may alternatively be used during specific implementation. This is not limited.

With reference to the communication system shown in FIG. 1, the following describes the measurement method provided in embodiments of this application. A first access network device, a second access network device, a core network device, and a terminal device that are described in the following embodiments may have the components shown in FIG. 3. Details are not described again.

FIG. 4 is a flowchart of a measurement method according to an embodiment of this application. As shown in FIG. 4, the method may include the following steps.

Step 101: A first access network device sends an application layer measurement configuration to a terminal device. Correspondingly, the terminal device receives the application layer measurement configuration from the first access network device.

The first access network device is any access network device in FIG. 1, for example, may be the access network device 1 in FIG. 1 or the access network device 2 in FIG. 1. In this embodiment of this application, an example in which the first access network device is the access network device 1 is used for description. The terminal device may be the terminal device connected to the first access network device in FIG. 1. A user may use a first service on the terminal device.

The application layer measurement configuration may be used to indicate the terminal device to perform quality of experience measurement and collection on the first service. The application layer measurement configuration may include a type of the first service and an indicator of quality of experience of the first service. The type of the first service may be used to uniquely identify a type of service to which the first service belongs, so that the terminal device learns of, based on the type of the first service, a service whose indicator of quality of experience is to be measured.

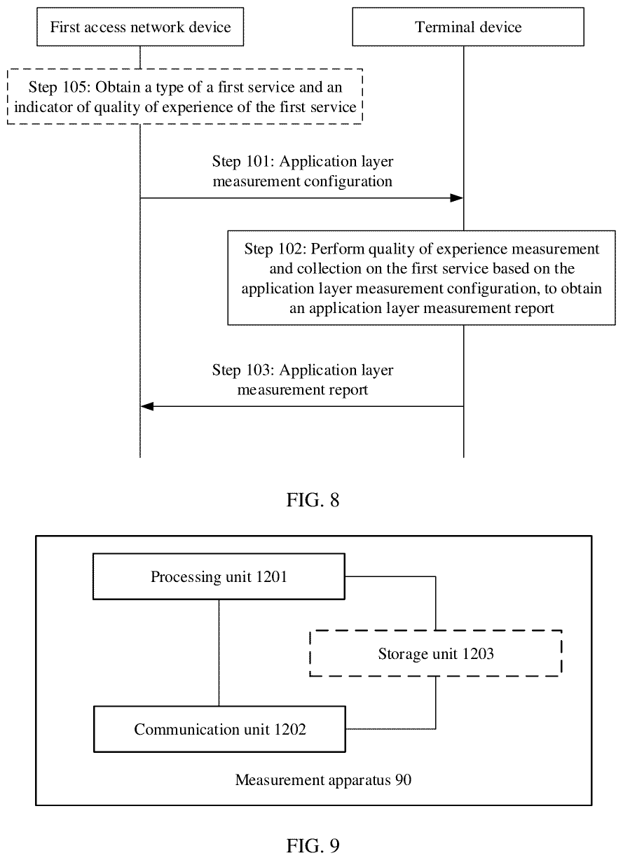

The type of the first service may include one or more of AR, VR, and 5GMS, and may further include another emerging service. This is not limited. For the indicator of quality of experience of the first service, refer to the foregoing description in Table 1 or Table 2. Specifically, the first access network device may obtain the indicator of quality of experience of the first service from another network element by using a method shown in FIG. 8.

The type of the first service may alternatively be an identifier of the first service. The identifier of the first service may uniquely identify the type of the first service. The identifier of the first service may be a number or a character, or may be a combination of the number and the character, or the like. This is not limited. For example, when the first service includes the AR, an identifier of the AR may be 1. When the first service includes the VR, an identifier of the VR may be 2. When the first service includes the 5GMS, an identifier of the 5GMS may be 3.

In a possible implementation, the first access network device sends the application layer measurement configuration to the terminal device by using a radio resource control (radio resource control, RRC) message. For example, the application layer measurement configuration may be carried in the RRC message and sent to the terminal device.

The RRC message may be an RRC connection reconfiguration message or an RRC connection resume message. The RRC connection reconfiguration message may be referred to as an RRC reconfiguration message for short. The RRC connection resume message may be referred to as an RRC resume message for short.

It should be noted that the first access network device may alternatively send the application layer measurement configuration to the terminal device by using another message, for example, send the application layer measurement configuration to the terminal device by using a measurement configuration application layer (MeasConfigAppLayer) message. This is not limited.

Step 102: The terminal device performs quality of experience measurement and collection on the first service based on the application layer measurement configuration, to obtain an application layer measurement report.

The application layer measurement report may include the type of the first service and a value corresponding to the indicator of quality of experience of the first service.

For example, when indicators of quality of experience of a service 1 are an indicator 1 of quality of experience, an indicator 2 of quality of experience, and an indicator 3 of quality of experience, a value of the indicator 1 of quality of experience of the service 1 is A1, a value of the indicator 2 of quality of experience of the service 1 is A2, and a value of the indicator 3 of quality of experience of the service 1 is A3. The application layer measurement report may include the service 1 {indicator 1 of quality of experience=A1, indicator 2 of quality of experience=A2, indicator 3 of quality of experience=A3}.

For example, that the terminal device performs quality of experience measurement and collection on the first service based on the application layer measurement configuration includes:

When the indicators of quality of experience are performance parameters of the terminal device, for example, the indicators of quality of experience whose sequence numbers are 1 to 24 in Table 1 and the indicators of quality of experience in Table 2, the terminal device may obtain preconfigured performance parameters of the terminal device from a local storage, and include the obtained performance parameters in the application layer measurement report.

When the indicators of quality of experience are indicators of user evaluation on performance of the terminal device, for example, the indicators of quality of experience whose sequence numbers are 25 to 32 in Table 1, the terminal device may obtain a user score in a human-computer interaction manner with the user. The human-computer interaction manner may be audio interaction, user interface (user interface, UI) interface interaction, or the like.

A UI interface is used as an example. FIG. 5 shows a UI interface of the terminal device, where the interface includes a display box and an input box. The display box is used to display a user score for performance of the terminal device. The input box is used by the user to enter the score for the performance of the terminal device. The score is used to indicate an experience status when the user uses the first service on the terminal device. In response to an entry operation of the user, the terminal device may obtain the user score for the performance of the terminal device.

Further, the terminal device may periodically obtain the user score for the performance of the terminal device, and perform combination processing on a plurality of scores to obtain a final user score for the performance of the terminal device, to ensure time validity and accuracy of the value of the indicator of quality of experience. The combination processing may include weighted processing, averaging processing, taking a maximum score value, taking a minimum score value, or the like, which is not limited.

For example, as shown in FIG. 5, an example in which the indicator of quality of experience is “video quality” is used. The terminal device may periodically display the UI interface shown in FIG. 5 to the user, periodically obtain user scores for video quality within a period of time, and use an average value of the scores within the period of time as a value of the video quality.

Step 103: The terminal device sends the application layer measurement report to the first access network device. Correspondingly, the first access network device receives the application layer measurement report from the terminal device.

In a possible implementation, the terminal device sends the application layer measurement report to the first access network device by using a dedicated message. For example, the dedicated message is a measurement report application layer (MeasReportAppLayer) message.

Alternatively, the terminal device may send the application layer measurement report to the first access network device by using the RRC message. For example, the terminal device may send the application layer measurement report to the first access network device by using an RRC connection reconfiguration complete message (which may also be referred to as an RRC reconfiguration complete message) or an RRC connection resume complete message (which may also be referred to as an RRC resume complete message).

According to the measurement method provided in this embodiment of this application, for an emerging service such as the VR, the AR, or the 5GMS of the terminal device, the access network device sends, to the terminal device, the application layer measurement configuration used to indicate the terminal device to perform quality of experience measurement and collection on the emerging service, so that the terminal device measures a related indicator of quality of experience of the emerging service based on the application layer measurement configuration, to obtain an application layer measurement report of a type of the emerging service, and sends the application layer measurement report to the access network device. After receiving the application layer measurement report, the access network device may perform, based on a value corresponding to the indicator of quality of experience in the application layer measurement report, network optimization on a wireless network used to transmit the service, so that an optimized wireless network can meet a transmission requirement of the service, to improve user experience when the user uses the first service.

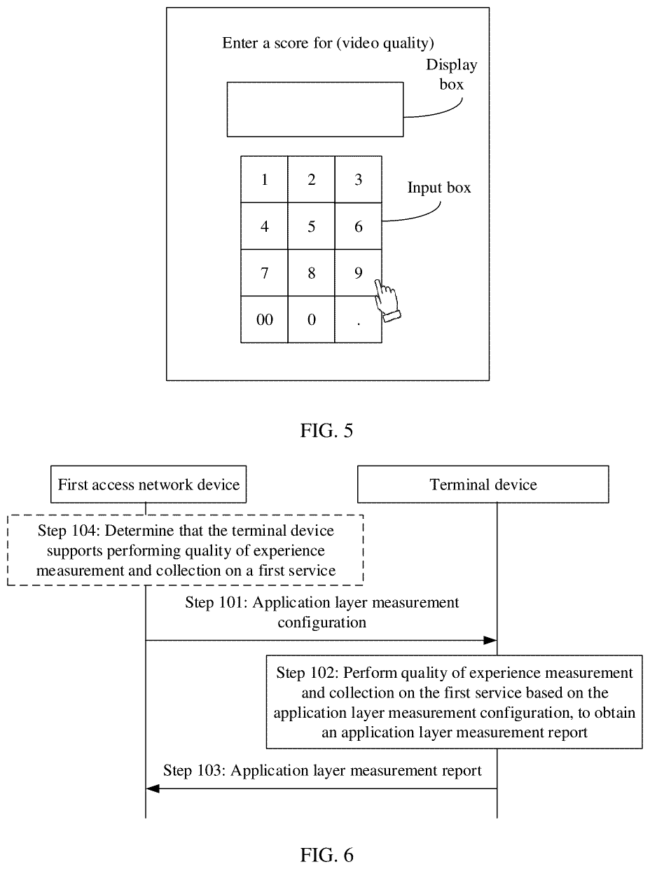

Based on the technical solution in FIG. 4, to improve measurement accuracy of the terminal device, as shown in FIG. 6, before step 101, the measurement method provided in this embodiment of this application may further include the following step.

Step 104: The first access network device determines that the terminal device supports performing quality of experience measurement and collection on the first service.

That the terminal device supports performing quality of experience measurement and collection on the first service means that the terminal device may measure the related indicator of quality of experience of the first service based on the application layer measurement configuration, to obtain the value corresponding to the indicator of quality of experience of the first service.

In a possible implementation, the first access network device obtains capability information of the terminal device, and determines, based on the capability information, that the terminal device supports performing quality of experience measurement and collection on the first service.

The capability information may include indication information used to indicate a service on which the terminal device supports performing quality of experience measurement and collection. The indication information may be used to indicate that the terminal device supports performing quality of experience measurement and collection on the first service.

In an example, the indication information includes M flag bits. One of the M flag bits is corresponding to one of M services that include the first service. When the indication information includes one flag bit, the first access network device determines that the terminal device supports performing quality of experience measurement and collection on a service corresponding to the flag bit. When the indication information does not include the flag bit, the first access network device determines that the terminal device does not support performing quality of experience measurement and collection on the service corresponding to the flag bit. M is an integer greater than or equal to 1.

The flag bit may be a symbol or a number, or may be a combination of the symbol and the number, or the like. This is not limited.

For example, a flag bit corresponding to the AR is A, a flag bit corresponding to the VR is V, and a flag bit corresponding to the 5GMS is M. When the indication information includes “A”, the first access network device determines that the terminal device supports performing quality of experience measurement and collection on the AR. When the indication information does not include “A”, the first access network device determines that the terminal device does not support performing quality of experience measurement and collection on the AR. When the indication information includes “V”, the first access network device determines that the terminal device supports performing quality of experience measurement and collection on the VR. When the indication information does not include “V”, the first access network device determines that the terminal device does not support performing quality of experience measurement and collection on the VR. When the indication information includes “M”, the first access network device determines that the terminal device supports performing quality of experience measurement and collection on the 5GMS. When the indication information does not include “M”, the first access network device determines that the terminal device does not support performing quality of experience measurement and collection on the 5GMS.

In another example, the indication information includes K bits. One of the K bits is corresponding to one of K services. When a value of a bit is T1, the first access network device determines that the terminal device supports performing quality of experience measurement and collection on a service corresponding to the bit. When a value of the bit is T2 or is not T1, the first access network device determines that the terminal device does not support performing quality of experience measurement and collection on the service corresponding to the bit. K is an integer greater than or equal to 1. T1 and T2 are integers, and T1 and T2 are different.

T1 and T2 may be binary bit numbers “0” and “1” or binary bit numbers “1” and “0”,or may be another symbol or number, or the like. This is not limited.

For example, the indication information includes three binary bits. The three binary bits are corresponding to the 5GMS, the VR, and the AR. That the binary bit is “0” indicates that the terminal device does not support performing quality of experience measurement and collection on a service corresponding to the binary bit. That the binary bit is “1” indicates that the terminal device supports performing quality of experience measurement and collection on the service corresponding to the binary bit. When the indication information includes 001, the first access network device determines that the terminal device supports performing quality of experience measurement and collection on the AR. When the indication information includes 010, the first access network device determines that the terminal device supports performing quality of experience measurement and collection on the VR. When the indication information includes 100, the first access network device determines that the terminal device supports performing quality of experience measurement and collection on the 5GMS.

In another example, the indication information may be a plaintext indication. For example, the indication information is as follows:

| | |
|---|---|
| qoe-VR-MeasReport | ENUMERATED {supported} |
| //Quality of experience-VR-Measurement Report | ENUMERATED {supported}; |
| qoe-5GMS-MeasReport | ENUMERATED {supported} |
| //Quality of experience-5GMS-Measurement Report | ENUMERATED {supported}. |

The indication information is used to indicate that the terminal device supports performing quality of experience measurement and collection on the VR and the 5GMS.

In a possible implementation, the terminal device may actively send the capability information of the terminal device to the first access network device.

For example, after setting up a communication connection to the first access network device, the terminal device actively sends the capability information of the terminal device to the first access network device. The terminal device may send the capability information of the terminal device to the first access network device by using an RRC message. The RRC message may be a terminal device capability information (UECapabilityInformation) message or a handover preparation information (HandoverPreparationInformation) message. The terminal device may alternatively send the capability information of the terminal device to the first access network device by using another message. This is not limited.

Further, the terminal device may periodically send the capability information of the terminal device to the first access network device. Alternatively, the terminal device may randomly send the capability information of the terminal device to the first access network device. This is not limited.

In this way, the terminal device sends the capability information of the terminal device to the first access network device, to avoid a problem caused because the terminal device still receives the application layer measurement configuration from the first access network device when the terminal device does not support performing quality of experience measurement and collection on the first service/does not have a capability of performing quality of experience measurement and collection on the first service, and improve accuracy of performing quality of experience measurement and collection on the first service by the terminal device.

In another possible implementation, the first access network device further obtains the capability information of the terminal device in any one of the following manner 1 to manner 3:

Manner 1: When the terminal device is communicatively connected to the first access network device, the first access network device may obtain the capability information of the terminal device by interacting with the terminal device.

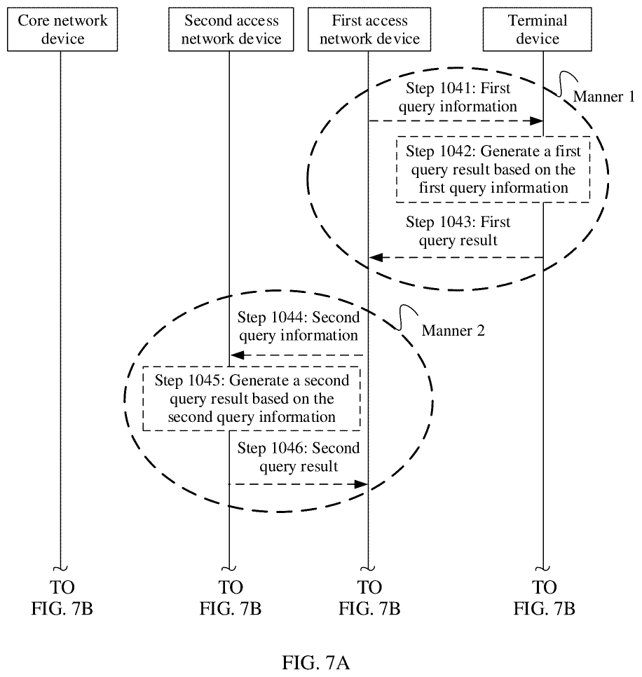

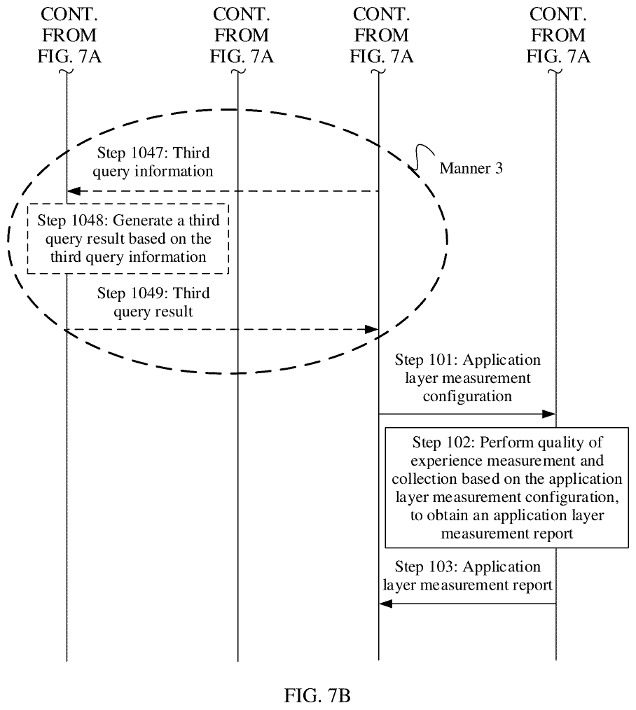

For example, refer to FIG. 7A and FIG. 7B. The manner 1 may be implemented by using the following steps.

Step 1041: The first access network device sends first query information to the terminal device. Correspondingly, the terminal device receives the first query information from the first access network device.

The first query information may be used to obtain the capability information of the terminal device.

Step 1042: The terminal device generates a first query result based on the first query information.

The first query result may include the capability information of the terminal device. For a description of the capability information, refer to the foregoing description. Details are not described.

Step 1043: The terminal device sends the first query result to the first access network device. Correspondingly, the first access network device receives the first query result from the terminal device.

Manner 2: When a second access network device has the capability information of the terminal device, the first access network device obtains the capability information of the terminal device by interacting with the second access network device.

The second access network device may be the access network device 2 in the system shown in FIG. 1.

For example, refer to FIG. 7A and FIG. 7B. The manner 2 may be implemented by using the following steps.

Step 1044: The first access network device sends second query information to the second access network device. Correspondingly, the second access network device receives the second query information from the access network device.

The second query information is used to obtain the capability information of the terminal device.

Step 1045: The second access network device generates a second query result based on the second query information.

The second query result and the first query result may be a same query result. Details are not described herein again.

Step 1046: The second access network device sends the second query result to the first access network device. Correspondingly, the first access network device receives the second query result from the second access network device.

Manner 3: When a core network device has the capability information of the terminal device, the first access network device obtains the capability information of the terminal device by interacting with the core network device.

For example, refer to FIG. 7A and FIG. 7B. The manner 3 may be implemented by using the following steps.

Step 1047: The first access network device sends third query information to the core network device. Correspondingly, the core network device receives the third query information from the access network device.

The third query information is used to obtain the capability information of the terminal device.

Step 1048: The core network device generates a third query result based on the third query information.

The third query result and the first query result may be a same query result. Details are not described herein again.

Step 1049: The core network device sends the third query result to the first access network device. Correspondingly, the first access network device receives the third query result from the core network device.

In this way, when determining that the terminal device supports performing quality of experience measurement and collection on the first service, the first access network device may send the application layer measurement configuration to the terminal device; when determining that the terminal device does not support performing quality of experience measurement and collection on the first service, the first access network device does not send the application layer measurement configuration to the terminal device, so that accuracy of quality of experience measurement and collection of the terminal device is improved. For example, if the first access network device determines that the terminal device supports performing quality of experience measurement and collection on the 5GMS, the first access network device sends, to the terminal device, an application layer measurement configuration that includes an indicator of quality of experience of the 5GMS. If the first access network device does not perform step 104, but directly performs step 101 of sending the application layer measurement configuration to the terminal device, the application layer measurement configuration includes an indicator of quality of experience of the AR and the indicator of quality of experience of the 5GMS. It is assumed that the terminal device supports performing quality of experience measurement and collection only on the 5GMS, in other words, the indicator of quality of experience of the AR in the application layer measurement configuration is a redundant indicator of quality of experience. In this way, the terminal device further needs to perform quality of experience measurement and collection on the indicator of quality of experience of the AR carried in the application layer measurement configuration. However, because the terminal device does not support performing quality of experience measurement and collection on the AR, accuracy of performing quality of experience measurement and collection by the terminal device is reduced.

In a possible embodiment, based on the technical solution in FIG. 4, as shown in FIG. 8, before step 101, the measurement method provided in this embodiment of this application may further include the following step.

Step 105: The first access network device obtains the type of the first service and the indicator of quality of experience of the first service.

In a possible implementation, the type of the first service and the indicator of quality of experience of the first service may be sent by the second access network device or the core network device to the first access network device. Alternatively, in another possible implementation, the type of the first service and the indicator of quality of experience of the first service may be sent by a control device to the first access network device.

The control device may also be referred to as a management system. The management system may be an operation administration and maintenance (operation administration and maintenance, OAM) system or a network management system. The control device may be configured to manage the first access network device. For example, an operator may install a program for the first access network device by using the control device, or configure a service type, an indicator of quality of experience, and the like for the first access network device by using the control device.

The following describes specific implementation processes of the foregoing two possible implementations of obtaining the type of the first service and the indicator of quality of experience of the first service by the first access network device.
1. The type of the first service and the indicator of quality of experience of the first service are sent by the second access network device or the core network device to the first access network device.

In an example, when an application layer measurement configuration is sent by the second access network device to the first access network device, the application layer measurement configuration may be carried in any one of a retrieve terminal device context response (retrieve UE context response) message, a handover request (handover request) message, a trace start (trace start) message, or a secondary node addition request (s-node addition request or SGNB addition request) message.

The retrieve terminal device context response message is used to transmit a context of the terminal device to the first access network device. The retrieve terminal device context response message includes the application layer measurement configuration. The handover request message is used to request to resource that is prepared for handover. The handover request message includes the application layer measurement configuration. The trace start message is used to initiate a trace record on the terminal device. The trace start message includes the application layer measurement configuration. The secondary node addition request message is used to request a resource that is prepared for a dual-connectivity operation of the terminal device. The secondary node addition request message includes the application layer measurement configuration of the terminal device.

In another example, when the application layer measurement configuration is sent by the core network device to the first access network device, the application layer measurement configuration may be carried in any one of an initial context setup request (initial context setup request) message, a handover request (handover request) message, or a trace start (trace start) message.

The initial context setup request message is used to request to set up the context of the terminal device. The initial context setup request message includes the application layer measurement configuration. For the handover request message and the trace start message, refer to the foregoing description. Details are not described herein again.
2. When the indicator of quality of experience of the first service is sent by the control device to the first access network device, the control device may have the memory shown in FIG. 3. The memory has a correspondence between the type of the first service and the indicator of quality of experience of the first service. For example, the correspondence may be shown in Table 3. In this case, the control device may send the type of the first service and the indicator of quality of experience of the first service to the first access network device.

TABLE 3

| Type of the first service | Indicator of quality of experience |
|---|---|
| AR | For details, see Table 1 |
| VR | For details, see Table 1 |
| 5GMS | For details, see Table 2 |

It should be noted that, for details about the indicator of quality of experience and the description of the indicator of quality of experience in Table 3, refer to Table 1 and Table 2. For example, when the type of the first service includes the AR or the VR, the indicator of quality of experience of the first service may be the indicator of quality of experience in Table 1. When the type of the first service includes 5GMS, the indicator of quality of experience of the first service may be the indicator of quality of experience in Table 2.

It should be noted that, in this embodiment of this application, before sending the type of the first service and the indicator of quality of experience of the first service to the first access network device, the second access network device or the core network device may determine that the terminal device supports performing quality of experience measurement and collection on the first service.

In an example, the first access network device actively sends the capability information of the terminal device to the second access network device or the core network device. For example, the first access network device periodically sends the capability information of the terminal device to the second access network device or the core network device.

In another example, the first access network device may alternatively send the capability information of the terminal device to the second access network device or the core network device based on a requirement of the second access network device or the core network device. For example, the second access network device or the core network device sends fourth query information to the first access network device. The fourth query information is used to obtain the capability information of the terminal device. After receiving the fourth query information from the second access network device or the core network device, the first access network device sends the capability information of the terminal device to the second access network device or the core network device.

In a possible embodiment, when the measurement method provided in this embodiment of this application is applied to the 5G communication system shown in FIG. 2, the first access network device in step 101 and step 103 may be replaced with a CU. In other words, step 101 may be that the CU sends the application layer measurement configuration to the terminal device, and step 103 may be that the CU receives the application layer measurement report from the terminal device. In this case, the measurement method provided in this embodiment of this application may further include step 106: The CU sends the application layer measurement report to a DU.

Alternatively, the first access network device in step 101 and step 103 may be replaced with a CU-CP. In other words, step 101 may be that the CU-CP sends the application layer measurement configuration to the terminal device, and step 103 may be that the CU-CP receives the application layer measurement report from the terminal device. In this case, the measurement method provided in this embodiment of this application may further include step 107: The CU-CP sends the application layer measurement report to a DU; or step 108: The CU-CP sends the application layer measurement report to a CU-UP.

In a possible embodiment, after receiving the application layer measurement report from the terminal device, the first access network device (or the DU or the CU-UP of the first access network device) may determine, based on the application layer measurement report, whether a wireless network used to transmit the service such as the AR, the VR, or the 5GMS needs to be optimized. For example, the first access network device may determine, based on the value corresponding to the indicator of quality of experience in the application layer measurement report, whether to optimize the wireless network used to transmit the service such as the AR, the VR, or the 5GMS. When the value corresponding to the indicator of quality of experience is less than a threshold, the first access network device determines that the wireless network used to transmit the service such as the AR, the VR, or the 5GMS needs to be optimized. The threshold may be preset. This is not limited.

When determining that the wireless network used to transmit the service such as the AR, the VR, or the 5GMS, needs to be optimized, the first access network device may optimize, in one or more of the following manners, the wireless network used to transmit the service such as the AR, the VR, or the 5GMS: (1) allocating cache resources; (2) selecting a radio bearer on which data packet scheduling needs to be performed; (3) managing a power level; and (4) managing a specific resource block that is used.

In this embodiment of this application, after receiving the application layer measurement report from the terminal device, the first access network device may further send the application layer measurement report to the second access network device, so that the second access network device optimizes, based on the application layer measurement report, a wireless network used to transmit the first service.

The following describes the foregoing manners by using an example in which the first service is the VR, the indicator of quality of experience is a mean opinion score, and the first access network device optimizes a wireless network used to transmit the VR.
1. When a mean opinion score of the VR is less than a first threshold (for example, a highest value corresponding to the mean opinion score is 10, and the first threshold may be 6), the first access network device may allocate a first preset quantity of cache resources to the VR. The first preset quantity is greater than a quantity of cache resources preconfigured for the VR. The first threshold may be preset. This is not limited. The cache resource preconfigured for the VR is a cache resource allocated by the first access network device to the VR when the mean opinion score is greater than or equal to the first threshold.
2. When the mean opinion score is less than the first threshold, the first access network device may select a radio bearer with a higher priority, to transmit data corresponding to the VR. Radio bearers have a plurality of levels, for example, a first level, a second level, and a third level. A priority of the first level is higher than a priority of the second level. A priority of the second level is higher than a priority of the third level. The first access network device may transmit the data of the VR by using a radio bearer corresponding to the first level, and transmit data of another service by using a radio bearer corresponding to the second level or the third level.
3. When the mean opinion score is less than the first threshold, the first access network device may increase a transmit power or a receive power required for the data corresponding to the VR. For example, the first access network device may send the data of the VR by using a first transmit power. The first transmit power is greater than a second transmit power. The second transmit power is a power required by the first access network device to send the data of the VR when the mean opinion score is greater than or equal to the first threshold.
4. When the mean opinion score is less than the first threshold, the first access network device may allocate a specific resource block (where the resource block is used only to transmit the data of the VR) to the VR.

The solutions in the foregoing embodiments of this application may be combined on a premise that there is no contradiction.

In the foregoing embodiments provided in this application, the method provided in embodiments of this application is described from perspectives of the access network device, the terminal device, and interaction between the access network device and the terminal device. It may be understood that, to implement the functions in the method provided in the foregoing embodiments of this application, each network element such as the access network device or the terminal device includes a corresponding hardware structure and/or software module for performing the functions. A person skilled in the art should easily be aware that, in combination with algorithms and steps in the examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application. However, this should not be considered that the implementation goes beyond the scope of this application.

In embodiments of this application, functional modules of the access network device and the terminal device may be divided based on the foregoing method examples. For example, each functional module may be obtained through division based on each corresponding function, or two or more functions may be integrated into one processing module. The integrated module may be implemented in a form of hardware, or may be implemented in a form of a software functional module. It should be noted that, in embodiments of this application, division into the modules is an example, and is merely logical function division. During actual implementation, another division manner may be used.

When an integrated unit is used, FIG. 9 is a schematic diagram of a possible structure of a measurement apparatus (denoted as a measurement apparatus 90) in the foregoing embodiments. The measurement apparatus 90 includes a communication unit 1202 and a processing unit 1201, and may further include a storage unit 1203. The schematic diagram of the structure shown in FIG. 9 may be used to show a structure of the terminal device in the foregoing embodiments.

When the schematic diagram of the structure shown in FIG. 9 is used to show the structure of the terminal device in the foregoing embodiments, the processing unit 1201 is configured to control and manage an action of the terminal device. For example, the processing unit 1201 is configured to: perform step 102 in FIG. 4 and step 1042 in FIG. 7A and FIG. 7B, and perform, by using the communication unit 1202, step 103 in FIG. 4, step 1043 in FIG. 7A and FIG. 7B, and/or an action performed by the terminal device in another process described in embodiments of this application. The processing unit 1201 may communicate with another network entity by using the communication unit 1202, for example, communicate with the access network device 1 shown in FIG. 1. The storage unit 1203 is configured to store program code and data of the terminal device.

When the schematic diagram of the structure shown in FIG. 9 is used to show the structure of the terminal device in the foregoing embodiments, the measurement apparatus 90 may be a terminal device, or may be a chip in the terminal device.

When the measurement apparatus 90 is a terminal device, the processing unit 1201 may be a processor or a controller. The communication unit 1202 may be a communication interface, a transceiver, a transceiver machine, a transceiver circuit, a transceiver apparatus, or the like. The communication interface is a collective term, and may include one or more interfaces. The storage unit 1203 may be a memory. When the measurement apparatus 90 is a chip in the terminal device, the processing unit 1201 may be a processor or a controller. The communication unit 1202 may be an input interface and/or an output interface, a pin, a circuit, or the like. The storage unit 1203 may be a storage unit (for example, a register or a cache) in the chip, or may be a storage unit (for example, a read-only memory (read-only memory, ROM for short) or a random access memory (random access memory, RAM for short)) outside the chip and in the terminal device or a first access network device.

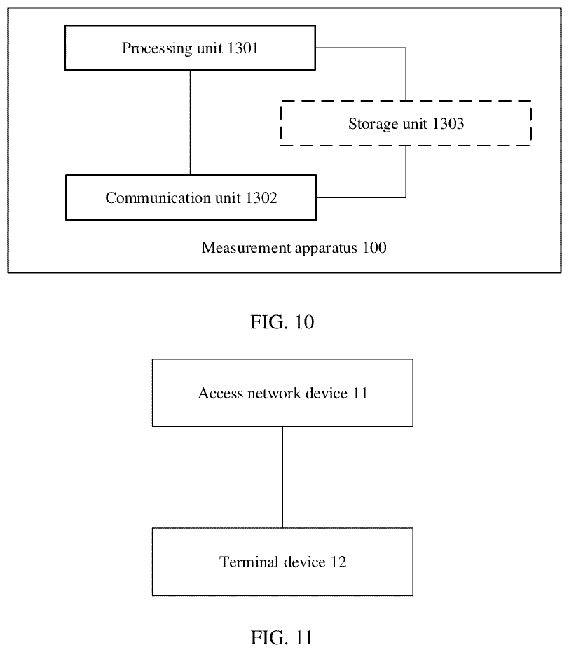

When an integrated unit is used, FIG. 10 is a schematic diagram of a possible structure of a measurement apparatus (denoted as a measurement apparatus 100) in the foregoing embodiments. The measurement apparatus 100 includes a communication unit 1302, and may further include a processing unit 1301 and a storage unit 1303. The schematic diagram of the structure shown in FIG. 10 may be used to show a structure of the first access network device in the foregoing embodiments.

When the schematic diagram of the structure shown in FIG. 10 is used to show the structure of the first access network device in the foregoing embodiments, the processing unit 1301 is configured to control and manage an action of the first access network device. For example, the processing unit 1301 is configured to perform, by using the communication unit 1302, step 101 in FIG. 4, step 104 in FIG. 6, step 1041, step 1044, and step 1047 in FIG. 7A and FIG. 7B, step 105 in FIG. 8, and/or an action performed by the first access network device in another process described in embodiments of this application. The processing unit 1301 may communicate with another network entity by using the communication unit 1302, for example, communicate with the terminal device shown in FIG. 1. The storage unit 1303 is configured to store program code and data of the first access network device.

When the schematic diagram of the structure shown in FIG. 10 is used to show the structure of the first access network device in the foregoing embodiments, the measurement apparatus 100 may be a first access network device, or may be a chip in the first access network device.

When the measurement apparatus 100 is a first access network device, the processing unit 1301 may be a processor or a controller. The communication unit 1302 may be a communication interface, a transceiver, a transceiver machine, a transceiver circuit, a transceiver apparatus, or the like. The communication interface is a collective term, and may include one or more interfaces. The storage unit 1303 may be a memory. When the measurement apparatus 100 is a chip in the first access network device, the processing unit 1301 may be a processor or a controller. The communication unit 1302 may be an input interface and/or an output interface, a pin, a circuit, or the like. The storage unit 1303 may be a storage unit (for example, a register or a cache) in the chip, or may be a storage unit (for example, a read-only memory (read-only memory, ROM for short) or a random access memory (random access memory, RAM for short)) outside the chip and in the terminal device or the first access network device.

The communication unit may also be referred to as a transceiver unit. Antennas and control circuits that are in the measurement apparatus 90 and the measurement apparatus 100 and that have a transceiver function may be considered as a communication unit of the measurement apparatus. A processor that has a processing function may be considered as a processing unit of the measurement apparatus. Optionally, a component that is in the communication unit and that is configured to implement a receiving function may be considered as a receiving unit. The receiving unit is configured to perform a receiving step in embodiments of this application. The receiving unit may be a receiver machine, a receiver, a receiver circuit, or the like. A component that is in the communication unit and that is configured to implement a sending function may be considered as a sending unit. The sending unit is configured to perform a sending step in embodiments of this application. The sending unit may be a transmitter machine, a transmitter, a transmitter circuit, or the like.

When integrated units in FIG. 9 and FIG. 10 each are implemented in a form of a software function module and sold or used as an independent product, the integrated unit may be stored in a computer-readable storage medium. Based on such an understanding, the technical solutions of embodiments of this application essentially, or the part contributing to the conventional technology, or all or some of the technical solutions may be implemented in the form of a software product. The computer software product is stored in a storage medium and includes several instructions to enable a computer device (which may be a personal computer, a server, a first access network device, or the like) or a processor (processor) to perform all or some of the steps of the methods described in embodiments of this application. The storage medium storing the computer software product includes any medium that can store program code, such as a USB flash drive, a removable hard disk, a read-only memory, a random access memory, a magnetic disk, or an optical disc.

The units in FIG. 9 and FIG. 10 may alternatively be referred to as modules. For example, the processing unit may be referred to as a processing module.

FIG. 11 is an example diagram of a communication system according to an embodiment of this application. The communication system includes an access network device 11 and a terminal device 12.

The access network device 11 is configured to perform the action performed by the access network device in the foregoing embodiments. For example, the access network device 11 is configured to perform step 101 in FIG. 4, step 104 in FIG. 6, step 1041, step 1044, and step 1047 in FIG. 7A and FIG. 7B, and step 105 in FIG. 8.

The terminal device 12 is configured to perform the action performed on the terminal device in the foregoing embodiments. For example, the terminal device 12 is configured to perform step 102 in FIG. 4, step 1042 in FIG. 7A and FIG. 7B, step 103 in FIG. 4, and step 1043 in FIG. 7A and FIG. 7B.

In an implementation process, steps of the methods in embodiments may be completed by using a hardware integrated logical circuit in the processor, or by using instructions in a form of software. The steps of the methods disclosed with reference to embodiments of this application may be directly performed by a hardware processor, or may be performed by using a combination of hardware in the processor and a software module.

The processor in this application may include but is not limited to at least one of the following computing devices that run software: a central processing unit (central processing unit, CPU), a microprocessor, a digital signal processor (DSP), a microcontroller unit (microcontroller unit, MCU), or an artificial intelligence processor. Each computing device may include one or more cores configured to perform an operation or processing by executing software instructions. The processor may be an independent semiconductor chip, or may be integrated with another circuit to form a semiconductor chip. For example, a SoC (system-on-a-chip) may include the processor and another circuit (for example, a codec circuit, a hardware acceleration circuit, or various buses and interface circuits). Alternatively, the processor may be integrated into an ASIC as a built-in processor of the ASIC, and the ASIC integrated with the processor may be independently packaged or may be packaged with another circuit. In addition to the core configured to perform an operation or processing by executing software instructions, the processor may further include a necessary hardware accelerator, for example, a field programmable gate array (field programmable gate array, FPGA), a PLD (programmable logic device), or a logic circuit that implements a dedicated logic operation.

The memory in embodiments of this application may include at least one of the following types: a read-only memory (read-only memory, ROM) or another type of static storage device that can store static information and instructions, or a random access memory (random access memory, RAM) or another type of dynamic storage device that can store information and instructions, or may be an electrically erasable programmable read-only memory (Electrically erasable programmable-only memory, EEPROM). In some scenarios, the memory may alternatively be a compact disc read-only memory (compact disc read-only memory, CD-ROM) or another compact disc storage medium, an optical disc storage medium (including a compact disc, a laser disc, an optical disc, a digital versatile disc, a Blu-ray disc, and the like), a magnetic disk storage medium or another magnetic storage device, or any other medium that can be configured to carry or store expected program code in a form of instructions or a data structure and that can be accessed by a computer. However, the memory is not limited thereto.

An embodiment of this application further provides a computer-readable storage medium, including instructions. When the instructions are run on a computer, the computer is enabled to perform any one of the foregoing methods.

An embodiment of this application further provides a computer program product including instructions. When the computer program product is run on a computer, the computer is enabled to perform any one of the foregoing methods.

An embodiment of this application further provides a communication system, including the foregoing first access network device and terminal device.

An embodiment of this application further provides a chip. The chip includes a processor and an interface circuit, where the interface circuit is coupled to the processor. The processor is configured to run a computer program or instructions, to implement the foregoing method. The interface circuit is configured to communicate with another module outside the chip.

All or some of the foregoing embodiments may be implemented by using software, hardware, firmware, or any combination thereof. When a software program is used to implement embodiments, all or some of embodiments may be implemented in a form of a computer program product. The computer program product includes one or more computer instructions. When the computer program instructions are loaded and executed on a computer, all or some of the procedures or functions according to embodiments of this application are generated. The computer may be a general-purpose computer, a special-purpose computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL for short)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (solid-state drive, SSD for short)), or the like.

Although this application is described with reference to embodiments, in a process of implementing this application that claims protection, a person skilled in the art may understand and implement another variation of the disclosed embodiments by viewing the accompanying drawings, disclosed content, and the appended claims. In the claims, “comprising” (comprising) does not exclude another component or another step, and “a” or “one” does not exclude a case of “a plurality of”. A single processor or another unit may implement several functions enumerated in the claims. Some measures are recorded in dependent claims that are different from each other, but this does not mean that the measures cannot be combined to produce a good effect.

Although this application is described with reference to specific features and embodiments thereof, it is clear that various modifications and combinations may be made to them without departing from the spirit and scope of this application. Correspondingly, the specification and accompanying drawings are merely example descriptions of this application defined by the appended claims, and are considered as any of and all modifications, variations, combinations or equivalents that cover the scope of this application. It is clear that a person skilled in the art can make various modifications and variations to this application without departing from the spirit and scope of this application. This application is intended to cover the modifications and variations of this application provided that they fall within the scope of the following claims and equivalent technologies of this application.

1. A measurement method, comprising:
receiving, by a terminal device, an application layer measurement configuration from a first access network device, wherein the application layer measurement configuration is usable to indicate to the terminal device to perform quality of experience measurement and collection on a first service, the application layer measurement configuration includes a type of the first service and an indicator of quality of experience of the first service, and the type of the first service includes one or more of augmented reality (AR), virtual reality (VR), or 5th generation media streaming (5GMS);
sending, by the terminal device, an application layer measurement report to the first access network device, wherein the application layer measurement report includes the type of the first service and a value corresponding to the indicator of quality of experience of the first service.

2. The method according to claim 1, wherein the sending the application layer measurement report includes sending the application layer measurement report obtained by performing quality of experience measurement and collection on the first service based on the application layer measurement configuration.

3. The measurement method according to claim 1, further comprising:
sending, by the terminal device, capability information to the first access network device, wherein the capability information is usable to indicate that the terminal device supports performing quality of experience measurement and collection on the first service.

4. The measurement method according to claim 3, wherein before the sending, by the terminal device, capability information to the first access network device, the method further comprises:
receiving, by the terminal device, first query information from the first access network device, wherein the first query information is usable to obtain the capability information of the terminal device.

5. The measurement method according to claim 1, wherein the receiving the application layer measurement configuration includes receiving the application layer measurement configuration carried in a radio resource control (RRC) reconfiguration message or an RRC resume message; and wherein the sending the application layer measurement report includes sending the application layer measurement report in a measurement configuration application layer message, or an RRC reconfiguration message or an RRC resume message.

6. An terminal device, comprising:
at least processor; and
a non-transitory computer-readable medium including computer-executable instructions that, when executed by the processor, cause the processor to be configured for:
receiving an application layer measurement configuration from a first access network device, wherein the application layer measurement configuration is usable to indicate to perform quality of experience measurement and collection on a first service, the application layer measurement configuration includes a type of the first service and an indicator of quality of experience of the first service, and the type of the first service includes one or more of augmented reality (AR), virtual reality (VR), or 5th generation media streaming (5GMS);
sending an application layer measurement report to the first access network device, wherein the application layer measurement report includes the type of the first service and a value corresponding to the indicator of quality of experience of the first service.

7. The terminal device according to claim 6, wherein the processor is configured to obtain the application layer measurement report by performing quality of experience measurement and collection on the first service based on the application layer measurement configuration.

8. The terminal device according to claim 6, wherein the processor is configured for:
sending, by the terminal device, capability information to the first access network device, wherein the capability information is usable to indicate that the terminal device supports performing quality of experience measurement and collection on the first service.

9. The terminal device according to claim 8, wherein the processor is configured for, before the sending, capability information to the first access network device:
receiving first query information from the first access network device, wherein the first query information is usable to obtain the capability information.

10. The terminal device according to claim 6, wherein the processor is configured to carry the application layer measurement configuration in a radio resource control (RRC) reconfiguration message or an RRC resume message; and wherein the processor is configured to carry the application layer measurement report in a measurement configuration application layer message, or an RRC reconfiguration message or an RRC resume message.

11. A first access network device, comprising:
at least processor; and
a non-transitory computer-readable medium including computer-executable instructions that, when executed by the processor, cause the processor to be configured for:
sending an application layer measurement configuration to a terminal device, wherein the application layer measurement configuration is usable to indicate the terminal device to perform quality of experience measurement and collection on a first service, the application layer measurement configuration includes a type of the first service and an indicator of quality of experience of the first service, and the type of the first service includes one or more of augmented reality (AR), virtual reality (VR), or 5th generation media streaming (5GMS); and
receiving an application layer measurement report from the terminal device, wherein the application layer measurement report includes the type of the first service and a value corresponding to the indicator of quality of experience of the first service.

12. The first access network device according to claim 11, wherein the processor is configured for sending an application layer measurement configuration to a terminal device by:
sending the application layer measurement configuration to the terminal device in response to determining that the terminal device supports performing quality of experience measurement and collection on the first service.

13. The first access network device according to claim 11, wherein the processor is configured for:
receiving capability information from the terminal device, wherein the capability information is usable to indicate that the terminal device supports performing quality of experience measurement and collection on the first service; and
determining, based on the capability information, that the terminal device supports performing quality of experience measurement and collection on the first service.

14. The first access network device according to claim 13, wherein the processor is configured for, before the receiving capability information from the terminal device:
sending first query information to the terminal device, wherein the first query information is usable to obtain the capability information of the terminal device.

15. The first access network device according to claim 11, wherein the processor is configured for:
receiving the type of the first service and the indicator of quality of experience of the first service from a second access network device or a core network device; or
configuring the type of the first service and the indicator of quality of experience of the first service by a control device.

16. The first access network device according to claim 11, wherein processor is configured as a centralized unit (CU) and a distributed unit (DU), wherein the processor is configured for;
sending, by a first access network device, an application layer measurement configuration to a terminal device by:
sending, by the CU, the application layer measurement configuration to the terminal device;
receiving an application layer measurement report from the terminal device by:
receiving, by the CU, the application layer measurement report from the terminal device; and
sending, by the CU, the application layer measurement report to the DU.

17. The first access network device according to claim 11, wherein the processor is configured for carrying the application layer measurement configuration in a radio resource control (RRC) reconfiguration message or an RRC resume message.

18. The first access network device according to claim 11, wherein the processor is configured for carrying the application layer measurement report in a measurement configuration application layer message, or an RRC reconfiguration message or an RRC resume message.

19. The first access network device according to claim 11, wherein the processor is configured for obtaining the application layer measurement report by performing quality of experience measurement and collection on the first service based on the application layer measurement configuration.

20. The terminal device according to claim 6, wherein the processor is configured as a system-on-a-chip.
